(19) United States
(12) Patent Application Publication
(10) Pub. No.: US 2006/0250270 A1
(43) Pub. Date: Nov. 9, 2006

(54) System and method for mounting a light emitting diode to a printed circuit board

(76) Inventor: Kyrre Tangen, Fredrikstad (NO)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/418,835

(22) Filed: May 5, 2006

Related U.S. Application Data
(60) Provisional application No. 60/678,412, filed on May 5, 2005.

(51) Int. Cl. G09F 9/33

(52) U.S. Cl. 340/815.45; 362/373

(57) ABSTRACT

A light emitting diode heat dissipation system is provided. The system typically includes a printed circuit board, a light emitting diode positioned adjacent the printed circuit board, and a heat sink positioned on an opposite side of the printed circuit board from the light emitting diode. The heat sink is typically configured to dissipate heat generated by the light emitting diode. The printed circuit board may include an opening formed intermediate the light emitting diode and the heat sink. The opening may be configured to facilitate heat transfer between a surface of the light emitting diode and a surface of the heat sink. Typically, at least one of the surface of the light emitting diode and the surface of the heat sink extends toward the opening in the printed circuit board.

### CROSS-REFERENCES TO RELATED APPLICATIONS

This application claims priority to U.S. Provisional Patent Application Ser. No. 60/678,412 filed May 5, 2005 entitled SYSTEM AND METHOD FOR MOUNTING A LIGHT EMITTING DIODE TO A PRINTED CIRCUIT BOARD, which is incorporated herein by reference in its entirety for all purposes.

### TECHNICAL FIELD

The present disclosure relates generally to systems and methods for cooling a light emitting diode, and more specifically to an improved system and method of cooling a light emitting diode mounted on a printed circuit board, and also to improved light emitting diodes, printed circuit boards and heat sinks.

### BACKGROUND AND SUMMARY

Display devices, such as projectors, can be used to present still and/or video images on a display surface. Example types of projectors include, but are not limited to front projectors, rear projectors, multi-media projectors, etc. Such projectors may be used in a variety of environments, such as, for example, the home, business or lecture halls, meeting rooms, conference rooms, theaters, etc. In some applications, the images can be supplied to the projector from an external device, such as a computer, video cassette player (VCP), digital versatile disk player (DVD player), memory card, telephone, hand-held computing device, etc.

Generation of a multi-colored image from the projector includes generation of a light of different colors. Various light sources may be used to supply or generate the color image. For example, in some embodiments, a white light source, e.g. metal halide lamps or high pressure xenon lamps, may be used in combination with a color wheel to generate desired colors in an image. However, such light sources may require high voltage and may produce a significant amount of heat in the system. Additionally, such light sources may have a short life time and, in some instances, a relative long warm-up period. Additionally, the size of the light source may restrict the development of portable and reduced sized projectors.

Recent efforts have included development of projection systems and devices which utilize colored light sources or bundled light sources, such as semiconductor diodes, e.g. light emitting diodes (LEDs), and other solid-state light sources, including but not limited to organic LEDs (OLEDs), laser diodes, edge emitting diodes, and vertical cavity surface emitting laser (VCSEL diodes). The inventors herein have recognized that the configuration and layout of the LEDs may improve the operation and use of such solid-state light sources in projectors and other devices. According to one aspect of the present invention, a light emitting diode heat dissipation system is provided. The system typically includes a printed circuit board, a light emitting diode positioned adjacent the printed circuit board, and a heat sink positioned on an opposite side of the printed circuit board from the light emitting diode. The heat sink is typically configured to dissipate heat generated by the light emitting diode. The printed circuit board may include an opening formed intermediate the light emitting diode and the heat sink. The opening may be configured to facilitate heat transfer between a surface of the light emitting diode and a surface of the heat sink. Typically, at least one of the surface of the light emitting diode and the surface of the heat sink extends toward the opening in the printed circuit board.

According to another aspect of the present invention, a method of dissipating heat produced by a light emitting diode mounted to a printed circuit board is provided. The method typically includes mounting the light emitting diode over a channel on a first side of the printed circuit board, mounting a heat sink over the channel on a second side of the printed circuit board, and thermally connecting a surface of the light emitting diode with a surface of the heat sink through the channel.

According to another aspect of the present invention, a printed circuit board assembly is provided. The printed circuit board assembly typically includes a printed circuit board, a heat sink mounted on a first side of the printed circuit board, and at least one light emitting diode mounted on a second side of the printed circuit board. Typically, the printed circuit board includes at least one opening for dissipating heat from the light emitting diode to the heat sink.

### BRIEF DESCRIPTION OF THE DRAWINGS

The disclosure is illustrated by way of example and not by way of limitation in the figures of the accompanying drawing, in which the like reference indicate similar elements and in which:

FIG. 1 is a schematic illustration of exemplary embodiments of light emitting diodes and a heat sink mounted to a printed circuit board.

FIG. 2 is a schematic illustration of light emitting diodes and a heat sink mounted to a printed circuit board.

FIG. 3 illustrates an exemplary rear projection device suitable for use with the printed circuit boards, light emitting diodes and heat sinks of FIGS. 1 and 2.

FIG. 4 illustrates an exemplary front projection device suitable for use with the printed circuit boards, light emitting diodes and heat sinks of FIGS. 1 and 2.

### DETAILED DESCRIPTION

Various configurations of solid-state light sources, printed circuit boards, and heat sinks may be used to realize the cooling concept and heat-dissipation configuration described herein. It should be appreciated that the embodiments and illustrations provided below are exemplary and are not intended in any limiting sense.

Although described herein in regards to the use of a light emitting diode, it should be appreciated that the following disclosure may equally apply, if not more so, to any one of the various semiconductor diodes or solid-state light sources. For example, the disclosure and configuration for the light sources may equally apply to organic LEDs (OLEDs), laser diodes, edge emitting diodes, vertical cavity surface emitting laser (VCSEL diodes), etc. Thus, although the examples set forth indicate the use of an LED, other semiconductor diodes and solid-state light sources may be used without departing from the scope of the disclosure.

Further, although the disclosure provides examples in regards to projection systems, including both front and rear projectors, the disclosure is not intended to be so limited. For example, the configuration of the light sources may be applicable in a variety of other environments and applications, including, but not limited to, various electronic indicator systems, image production, data transmission applications, lighting, data information devices, including clocks, computers, telephones, signage, appliances, etc.

Referring now more specifically to a first embodiment of the disclosure, LEDs typically including a light emitting semiconductor material, a case or housing enclosing the semiconductor material, a cathode (negative terminal) and an anode (positive terminal). LEDs may be adapted to emit light when current is passed through the semiconductor material. Known LEDs can produce light of various colors, including red, yellow, green, blue, white, etc. In some embodiments, like-colored LEDs may be bundled to emit additional light.

As discussed above, LEDs may be used to generate light for image displays, for example, in a front or rear projection display devices or projectors. As an example, in some embodiments, a pixel may be illuminated by a small light-producing module including red, green and blue LEDs that together produce white light. Other modules may include other LED colors or include white LEDs in the module. A plurality of these LEDs modules may be arranged, such as in a rectangular grid pattern, to form the light source for the image display. In other embodiments, white LEDs may be used in combination with a color wheel or similar device.

Heat generation may be a factor to be considered in some LED applications, and particularly in high power applications. For example, in some high power applications, such as in use in a display device, a relatively large current may be used to produce an intense light beam from one or more LEDs. In some applications, a plurality of high power LEDs may be mounted together in a small area. For example, when LEDs are designed to act as a light source for a projection device, the LEDs may be arranged in clusters to concentrate and focus the light. As an exemplary embodiment, a large-screen rear projection television set may utilize such an array of LEDs. In these cases, large amounts of heat may be generated by the LEDs. Heat sinks and/or forced cooling systems may be required to dissipate the heat to avoid overheating the LED. A heat sink may include structures to increase heat dissipation. For example, a heat sink may include a plurality of fins or combs configured to increase surface contact with air for a higher rate of heat dissipation.

LEDs, used as light sources in a display device environment, may be mounted or coupled to a printed circuit board (PCB). Mounting the LEDs to the PCB may provide a reliable means of connecting the terminals of the LEDs to an electronic circuit. In some embodiments, a heat sink may be used to dissipate heat from a plurality of LEDs mounted on a printed circuit board. Where the heat sink is placed on the side of printed circuit board opposite to the side on which the LEDs are mounted, the heat dissipated from the LEDs may spread through the printed circuit board before it can reach the heat sink. Since materials from which the printed circuit boards are commonly made tend to be poor heat conductors, the heat generated from the LEDs may not be efficiently dissipated into the heat sink. The lack of efficient heat dissipation and the spread of heat through the PCB may result in damage (such as damage due to overheating) to the LEDs. Further, the accumulation and spread of heat throughout the PCB may result in potential damage, to not only the mounted LEDS, but to the printed circuit board, components on the circuit board and/or nearby components.

In some embodiments, the LEDs, printed circuit board and the heat sink may be arranged or disposed in a heat-dissipation configuration. In an example heat-dissipation configuration, a path of high thermal conductivity may be provided between the mounted LEDs and the heat sink. In some embodiments, the path of high thermal conductivity may be controlled such that it substantially bypasses the printed circuit board and the other components on the printed circuit board. Additionally, in some embodiments, the heat-dissipation configuration may make the thermal resistance between the LEDs and the heat sink smaller resulting in improved heat dissipation.

The heat-dissipating configuration for the LEDS may result in improved cooling of the LEDS on the board. Further, the reduction in overall heat and cooler operation may enable the LEDs to be operated at an increased power level with less danger of overheating. The heat-dissipating configuration may also allow system cooling requirements to be reduced by allowing the area and/or size of the heat sink and/or an airflow volume used for cooling to be decreased compared to conventional printed circuit board mounting configurations. Additionally, the disclosed heat-dissipating configurations may further allow removal or reduced number of cooling fans in the system. Thus, the heat-dissipation configuration, as disclosed herein, may result in reduced system cost, reduced system size, increased light output and increased reliability and lifetime, of the device, the LEDs, the PCB and the PCB components.

As discussed above, in some embodiments, the heat-dissipation configuration shown in the figures, and described, provides for an LED mounting configuration where the LED is mounted to reduce heat to the PCB. In some embodiments, the heat-dissipation configuration may include providing a cut-out in the PCB beneath the LED such that the LED may directly transfer heat to the heat sink. In other embodiments, the LED case may be extended such that there is a substantially direct path to the heat sink. In some embodiments, the casing itself may function as a heat sink.

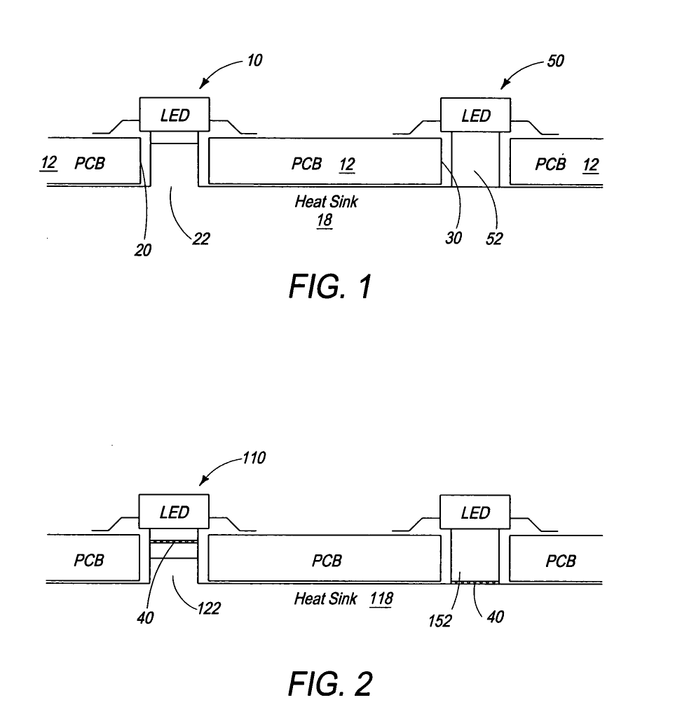

FIG. 1 shows two exemplary heat dissipation configurations for mounting LEDs a printed circuit board. In one embodiment, LED 10 is mounted on printed circuit board 12. Heat sink 18 is disposed on another side of printed circuit board 12 than LED 10 to dissipate heat produced by LED 10 and printed circuit board 12.

In some embodiments, printed circuit board 12 may include an opening (also referred to as a channel) 20 to accommodate an extension 22 of heat sink 18. Extension 22 may extend through printed circuit board 12 and may contact a lower surface of LED 10. This configuration may result in substantially direct transfer of heat from LED 12 to heat sink 18 reducing the transfer of heat through the printed circuit board 12. By providing a channel for the heat, heat generated from LED 10 may be efficiently transferred to heat sink 18 for dissipation with a reduced amount of heat transferred to the PCB and the other components mounted on the PCB.

It should be appreciated that any suitable heat sink configuration and/or material may be used as heat sink 18. Examples materials include, but are not limited to, aluminum, copper or any other highly conductive material. In some embodiments, various methods may be used to increase the transfer of heat from the LED to the heat sink. For example, the surface of the heat sink that contacts the LED and/or PCB may be highly polished to increase the contact surface area.

FIG. 1 also shows another exemplary embodiment. Although two embodiments are illustrated on the same circuit board, it should be understood that either one embodiment or the other embodiment may be implemented alone or in combination on a single board.

In the second embodiment, illustrated in FIG. 1, printed circuit board 12 may include an opening or aperture 30. LED 50 may include a downward extension 52 adapted to engage or operably contact heat sink 18. In some embodiments, downward extension 52 may include a heat slug to further improve the performance of the thermal junction between downwardly extension 52 and heat sink 18. A heat slug may be any form of conductive material that may improve heat dissipation. In some configurations, the heat slug may be incorporated into the casing of the LED. Accordingly, LED 50 may be in substantially direct or indirect contact with heat sink 18 substantially bypassing the board and the other board components. Through this configuration a reduced level of heat generated by the LED is transferred or conducted through a path along the printed circuit board 12 to reach heat sink 18.

FIG. 2 illustrates other exemplary embodiments of LEDs mounted to a printed circuit board. In these embodiments, gaps or spaces may be formed between the LEDs and the heat sink. The gaps may be filled or substantially filled with a highly thermally conductive material (also referred to as a thermal interface material) 40. The thermal interface material may be disposed within the space to substantially complete the thermally conductive path between the LED and the heat sink. In other words the thermal interface material conductively connects the LED to the heat sink. The use of thermal interface material 40 may further enhance the heat transfer, and may allow less stringent manufacturing tolerances than where the LED and heat sink are in direct contact. In some applications, thermal interface material may improve heat dissipation by exploiting surface area contact not achieved from direct contact between an LED and a heat sink.

Some forms of thermal interface material may include phase change material which can further ease the manufacturing process, due to the fact that at room temperature the material may be substantially solid making the material easy to handle and to apply to a PCB or LED. During operating conditions the phase change material can reach a certain temperature and can liquefy to lubricate and improve rate of heat dissipation between surfaces.

Any suitable thermal interface material may be used as thermally conductive material 40. Examples include, but are not limited to, thermally conductive metals, polymers, pastes, etc. As shown by FIG. 2, in one embodiment, thermally conductive material 40 is placed between LED 110 and heat sink extension 122. In another embodiment, thermal conductive material 40 is disposed between extension LED extension 152 and heat sink 118. It will be appreciated that thermally conductive material 40 may be omitted where the radiative and/or convective heat transfer between the heat sink and the LED is sufficient for cooling the LED.

It should be appreciated that many variations may be made to the above disclosed embodiments. For example, as shown by FIG. 1, in one embodiment, extension or casing 52 of LED 50 may extend through opening 30 only part way to heat sink 18. In other embodiments, LED extension 52 may extend to any position inside opening 30. Further in some embodiments, the casing itself or a portion of the casing may be considered a heat sink.

In yet other embodiments, an LED mounted above an opening of the printed circuit board has a downward extension extending toward and/or into the opening in the printed circuit board, and the heat sink on the other side of the printed circuit board has an upward extension also extending toward and/or into the opening. The two extensions may make contact in any suitable position inside the opening. Additionally, in even other embodiments, a thermally conductive material is placed between two extensions to enhance the heat transfer from the LED to the heat sink.

Moreover, the extensions of the LEDs and/or heat sinks may have any suitable cross-sectional shapes. Examples of suitable cross-sectional shapes include, but are not limited to, curvilinear, polygonal, and other such shapes. Additionally, the extensions may have any suitable size to accommodate the size of LEDs and layout of the printed circuit board. Furthermore, an LED may have more than one extension extending through the circuit board, and the heat sink may have more than one extension extending toward a single LED.

Further, the opening in the printed circuit board may have various configurations. For example, an opening may include a single opening for a single LED. In another embodiment, an opening may be configured into a narrow, elongate rectangle so that several LEDs may be mounted above one opening. In yet another embodiment, an opening may have a semicircular or other curved or angled shape to accommodate several LEDs based on the layout of the printed circuit board and the needs of the applications.

In some embodiments, the PCBs may be modular and may include a repeated pattern of openings configured to cooperate with LED and heat sink configurations to improve heat dissipation. Depending on the application, a different number of PCB modules may be combined to form a desired size of LED array. In some embodiments, a plurality of different colored LEDs may be grouped such that each grouping can be arranged in a single opening or in a pattern of openings in the printed circuit board. In such a configuration, the colored groupings of LEDs can be repeated in various patterns to produce a desired LED array. It would be appreciated that these configurations are only exemplary, and that an LED, printed circuit board, and/or heat sink may have other suitable configurations.

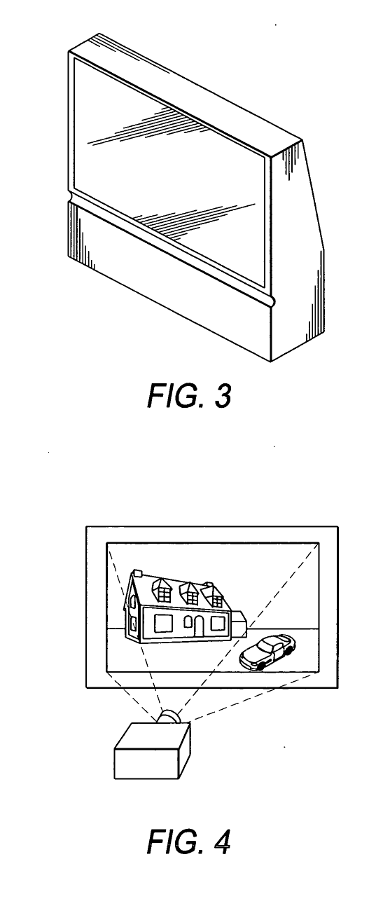

As described above, the use of the LED, printed circuit board and heat sinks described herein may be used in any suitable device, including devices with high power requirements, such as for projection. In these devices, the LEDs may be used to replace the traditional lamp as a light source. For example, FIG. 3 shows an exemplary rear projection device that may utilize LEDs, printed circuit boards and/or heat sinks according to the present disclosure in a light source. In this example device, various amounts of LEDs mounted on printed circuit boards may be used to create a desired size, shape, and intensity of projection surface. Furthermore, the printed circuit boards may be orientated in a variety of ways and any number of LEDs and heat sinks may be mounted on the printed circuit board in a configuration that can accommodate the orientation of the printed circuit board in the projection device.

FIG. 4 shows an exemplary front projection device that also may utilize the LEDs, printed circuit boards and heat sinks disclosed herein. The projection device may include a number of LEDs arranged close together to produce a high intensity source of light. The associated heat produced during production of the light can be dissipated directly from the LEDs to the heat sink, in this way heat can bypass the printed circuit board and heat dissipation from the LEDs can be improved. It will be appreciated that FIGS. 3 and 4 illustrate just a few exemplary LED applications that require intensely focused light, and that the LEDs, printed circuit boards and heat sinks described herein may be utilized in many other types of devices.

It will be appreciated that the configurations and embodiments disclosed herein are exemplary in nature, and that these specific embodiments are not to be considered in a limiting sense, because numerous variations are possible. The components, shapes, colors, etc. described herein are non-limiting examples and it should be understood that each of these features may be changed.

The subject matter of the present disclosure includes all novel and nonobvious combinations and subcombinations of the various systems and configurations, and other features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A light emitting diode heat dissipation system comprising:
a printed circuit board;
a light emitting diode positioned adjacent the printed circuit board;
a heat sink positioned on an opposite side of the printed circuit board from the light emitting diode, the heat sink being configured to dissipate heat generated by the light emitting diode;
wherein the printed circuit board includes an opening formed intermediate the light emitting diode and the heat sink, the opening being configured to facilitate heat transfer between a surface of the light emitting diode and a surface of the heat sink; and
wherein at least one of the surface of the light emitting diode and the surface of the heat sink extends toward the opening in the printed circuit board.

2. The system of claim 1, wherein the surface of the light emitting diode extends through the opening of the printed circuit board.

3. The system of claim 1, wherein the surface of the heat sink extends through the opening of the printed circuit board.

4. The system of claim 1, wherein both the surface of the light emitting diode and the surface of the heat sink extend into the opening of the printed circuit board.

5. The system of claim 1, wherein two or more light emitting diodes contact the heat sink through a single opening of the printed circuit board.

6. The system of claim 1, further including a thermally conductive material disposed between the light emitting diode and the heat sink.

7. The system of claim 1, wherein the light emitting diode includes a plurality of surfaces that extend into the opening of the printed circuit board and contact the heat sink.

8. The system of claim 1, wherein the heat sink includes a plurality of surfaces that extend into the opening of the printed circuit board and contact the light emitting diode.

9. The system of claim 1, wherein the opening in the printed circuit board has a curvilinear shape.

10. The system of claim 1, wherein the light emitting diode further includes a heat slug.

11. A method of dissipating heat produced by a light emitting diode mounted to a printed circuit board, the method comprising:
mounting the light emitting diode over a channel on a first side of the printed circuit board;
mounting a heat sink over the channel on a second side of the printed circuit board; and
thermally connecting a surface of the light emitting diode with a surface of the heat sink through the channel.

12. The method of claim 11, wherein a thermally conductive material is positioned in the channel between the surface of the light emitting diode and the surface of the heat sink, and the thermally conductive material facilitates a conductive connection between the light emitting diode and the heat sink.

13. The method of claim 11, wherein at least one of the light emitting diode and the heat sink are mounted at least partially in the channel.

14. A printed circuit board assembly, comprising:
a printed circuit board;
a heat sink mounted on a first side of the printed circuit board;
at least one light emitting diode mounted on a second side of the printed circuit board;
wherein the printed circuit board includes at least one opening for dissipating heat from the light emitting diode to the heat sink.

15. The printed circuit board assembly of claim 14, wherein the at least one light emitting diode includes multiple surfaces that extend through the opening of the printed circuit board and connect to the heat sink.

16. The printed circuit board assembly of claim 14, further including a thermally conductive material for dissipating heat positioned in the opening between the at least one light emitting diode and the heat sink.

17. The printed circuit board assembly of claim 14, wherein a surface of the heat sink extends at least partially through the opening and connects to a surface of the at least one light emitting diode.

18. The printed circuit board assembly of claim 14, wherein a surface of the at least one light emitting diode at least partially extends through the opening and connects to the heat sink.

19. The printed circuit board assembly of claim 14, wherein the at least one light emitting diode further includes a heat slug.

20. The printed circuit board assembly of claim 14, wherein the at least one light emitting diode includes a plurality of different colored light emitting diodes.
